(19) United States
(12) Patent Application Publication
(10) Pub. No.: US 2012/0319896 A1
(43) Pub. Date: Dec. 20, 2012

(54) GEOLOCATION SYSTEM AND METHOD HYBRIDIZING A SATELLITE NAVIGATION SYSTEM AND A DATA COLLECTION SYSTEM

(75) Inventors: Thibaud Calmettes, Toulouse (FR); Michel Monnerat, Saint Jean (FR)

(73) Assignee: THALES, NEUILLY SUR SEINE (FR)

(21) Appl. No.: 13/515,868

(22) PCT Filed: Dec. 1, 2010
(86) PCT No.: PCT/EP2010/068610

§ 371 Date: Jul. 20, 2012

(30) Foreign Application Priority Data
Dec. 15, 2009 (FR) 0906061

(51) Int. Cl. G01S 19/09

(52) U.S. Cl. 342/357.46

(57) ABSTRACT

Method of geolocation employing hybridization of a satellite navigation system and a data collection system. The method minimizes processing time by the means equipping the objects to be geolocated, given the processing effected in “masked time” by remote equipment, typically ground stations of the data collection system. To this end, the method necessitates only acquisition of the code phase of the positioning information coming from the satellite navigation system.

The present invention firstly concerns a geolocation system employing hybridization of a satellite navigation system and a data collection system.

In particular, the present invention provides for combining some of the signals from a satellite navigation system with measurement elements effected by a data collection system with the aim of determining the precise geographical location of an object, quickly and economically from an energy point of view.

One objective of the invention is to maximize the autonomy of the claimed geolocation system by minimizing acquisition and processing operations effected by means situated on the object to be located. According to the invention, as many operations as possible are effected by remote elements belonging to the data collection system.

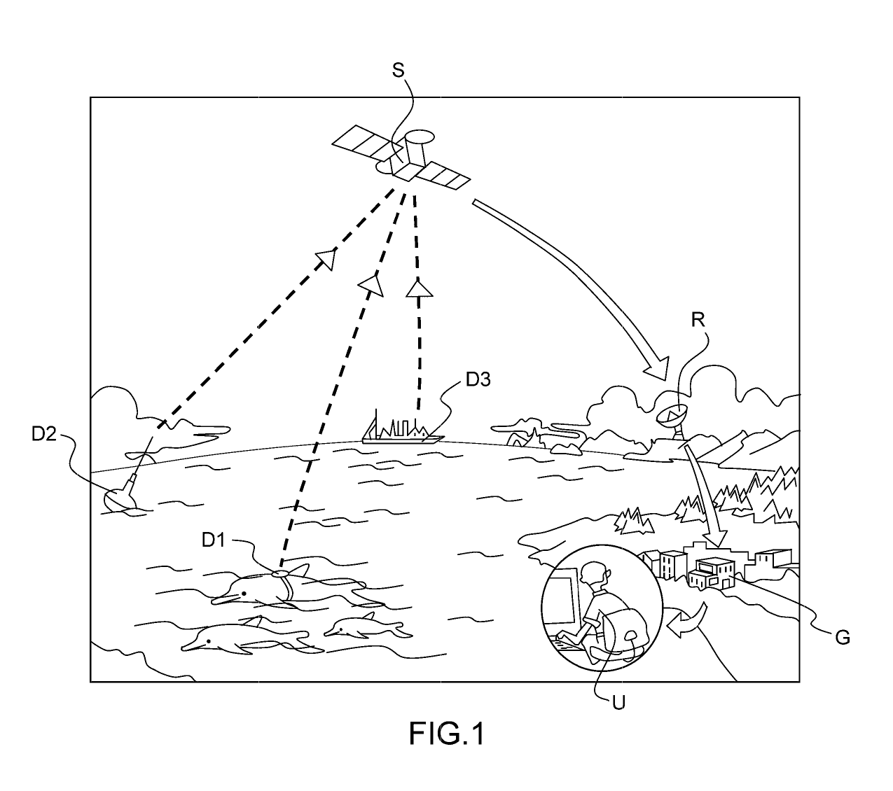

Numerous data collection systems are now used for diverse purposes: study of fauna, the environment, ship distress beacons, maritime traffic surveillance systems, etc. The Argos system, which has been in operation since 1979, is one well known example. However, there exist other data collection systems such as the AIS (Automatic Identification System) and the SAR (Search And Rescue) system, for example. The general operating principle of a data collection system is represented in FIG. 1.

Thus, in the FIG. 1 diagram, data collection devices equip an animal population D1, meteorological buoys D2 or a fleet of fishing boats D3, for example. The measurements effected by these devices are encapsulated in messages sent via appropriate transmitter devices to satellites S. Said satellites S relay these messages, possibly modified and possibly accompanied by measurements of the received signal, to receiver stations R on the ground. These forward the messages to ground stations G that have appropriate processing means, for example enabling approximate location of the objects under study or surveillance. After processing of the messages transmitted by the satellites S and the receiving stations R, the ground stations G can send information messages to a user network U. However, the geolocation of an object by a data collection system alone is insufficient because it is too inaccurate. The accuracy of such systems is only 300 to 500 meters, because of their intrinsic defects, and notably insufficiently accurate internal clocks and the small number of measurements.

Moreover, it is known that to determine the position of an object on the surface of the Earth it is possible to use the capabilities of a Global Navigation Satellite System (GNSS) such as the Global Positioning System (GPS), the Glonass system or, soon, the Galileo system. To implement a satellite navigation system it is necessary to equip the object to be located with means for acquisition of signals transmitted by the satellites of the navigation system. Those signals must be decoded by means associated with the aforementioned acquisition means in order to calculate the position of the object. Those means consist in a receiver or a beacon such as a GPS receiver or a GPS beacon.

The use of such geolocation means has a number of drawbacks.

Firstly, geolocation by a satellite navigation system implies decoding signals coming from said satellite navigation system, such as the GPS. The decoding of a complete GPS signal can take approximately 30 seconds to one minute for the calculation of a first point. During those 30 seconds, the GPS beacon used to acquire and decode the GPS signal, and installed on the object to be geolocated, is powered up, which affects the autonomy of said GPS beacon. Moreover, during those 30 seconds to one minute, there must be a clear sky and to be more precise a sufficient number of—at least 4—satellites visible. This is virtually impossible when the aim is to track a population of amphibious animals.

Moreover, for this type of system to be able to geolocate an object, the entirety of the GPS signal must be readable. If, because of poor reception quality, part of the GPS signal is lacking, no geolocation is possible. This drawback is reflected in a sensitivity (i.e. a reception capacity) that is potentially insufficient in geolocation systems using a satellite navigation system.

To alleviate these problems, some systems currently being developed are leading to the design of beacons, for example GPS signal receivers, that digitize said GPS signals without processing them and forward them to satellites in order for the geolocation calculation to be effected by external means, typically one or more ground stations. This solution has two serious disadvantages, however: firstly, it implies a high uplink data rate because all of the GPS signal is relayed; secondly, according to this solution, the object to be tracked or under surveillance, and in any event to be geolocated, does not know its position.

Accordingly, a first objective of the present invention is to improve the performance of geolocation systems, notably in terms of sensitivity. Another objective of the invention is to enable simplification of the receiving means equipping the objects to be geolocated, notably with a view to minimizing their energy consumption and, consequently, to increasing their autonomy. To achieve these objectives, the present invention does not imply any significant increase in the data rate of the uplink to the satellites S.

To this end, the invention consists in a method of geolocation of an equipment, comprising the following steps:
reception by receiving means situated on said equipment of positioning information coming from a satellite navigation system, said positioning information containing at least one code phase measurement;
transmission of messages, by transmission means situated on the equipment and belonging to a data collection system, said messages containing said code phase measurements, and measurements on the transmission of the messages, effected by measuring means belonging to said data collection system;
combination by processing means remote from the equipment and belonging to said data collection system of said code phase measurements and said measurements on the transmission of the messages, in such a manner as to geolocate said equipment.

Said measurements on the transmission of the messages preferably contain a measurement of the date and time of reception by relay means remote from the equipment of the messages transmitted by the transmission means of said data collection system.

The method of the invention may advantageously comprise the combination of said measurement of the date and time of reception and a date and time of transmission of said message by the transmission means in such a manner as to calculate the propagation distance between the equipment and the relay means of the data collection system.

In one embodiment of the method the date and time of transmission of said message by the transmission means are determined by a resolution of ambiguity based on the possible propagation distances between the equipment and the relay means of the data collection system, given the position of said relay means at the moment of reception of said message.

The determination of said transmission date and time may advantageously utilize an estimate of the time elapsed between the production of the code phase measurements and the transmission of the message via the data collection system to reduce the ambiguity resolution domain.

Said measurements on the transmission of the messages advantageously contain a Doppler measurement, i.e. a measurement of the difference between the frequency at which the messages are transmitted by the transmission means and the frequency at which said messages are received by the relay means of the system for collecting those same messages.

The method of the invention may advantageously include a step of determination of the absolute position of the satellite or satellites of the satellite navigation system originating said positioning information, comprising the association of said code phase measurements with an identifier characteristic of the satellite that sent said positioning information concerned, said identifier enabling determination of the absolute position of the satellite or satellites of the satellite navigation system by consultation of the ephemerides relating to the satellite navigation system concerned.

The method of the invention may advantageously include a step of determination of the absolute position of the satellite or satellites of the satellite navigation system originating said positioning information, comprising the resolution of the position of one or more satellites by comparison of a set of possible positions determined as a function of the ephemerides of the satellite navigation system concerned with geolocation information specific to said data collection system.

According to the invention, a system for geolocation of an equipment may comprise means situated on said equipment for receiving positioning information from a satellite navigation system, said positioning information containing at least one code phase measurement, and transmission means, situated on said equipment and belonging to a data collection system, for sending messages containing said code phase measurements and measurements on the transmission of the messages effected by measurement means belonging to said data collection system, and be adapted to implement the method according to the invention as defined above.

Such a geolocation system may advantageously comprise relay means and processing means remote from said equipment and belonging to said data collection system, respectively comprising a network of satellites and a network of ground stations.

The equipment advantageously supplies current to said positioning information receiving means only during a time period necessary and sufficient to effect said code phase measurements on the signals coming from the satellite navigation system.

The system according to the invention may advantageously return to the equipment a message including its geolocation.

In one embodiment the system according to the invention broadcasts continuously to a network of users the absolute time provided by the satellite navigation system.

Other features and advantages of the invention will become apparent in the light of the following description given with reference to the single appended drawing, FIG. 1, which represents the operating principle of a data collection system.

FIG. 1 is a diagram used to describe a prior art data collection system. This diagram may also serve to describe the invention.

The general operating principle of a prior art data collection system has already been briefly outlined in the introduction.

As also described hereinabove, known geolocation systems enable relatively accurate location of any object situated on the surface of the Earth equipped with a beacon able to decode the signals transmitted by satellites of the satellite navigation system concerned. As has been explained, these systems have the main drawbacks of necessitating a long decoding and processing time by the beacon onboard the subject to be located, and having a low sensitivity.

The basic principle of the invention consists in hybridizing a data collection system and a satellite navigation system. In other words, in accordance with the invention, the objects D1, D2, D3 to be located include not only beacons equipped with means for effecting measurements, belonging to the data collection system and beacons adapted to receive signals from satellites belonging to a satellite navigation system, but also and above all the means of the data collection system and the means for receiving signals from satellites belonging to a satellite navigation system are adapted to cooperate with a view to providing an accurate geolocation of said objects quickly, in particular where the calculation of the first point is concerned.

To this end, the system of the invention is designed so that as little processing as possible is effected by the means equipping the objects to be located. In particular, according to the invention, the means for receiving the signals from the satellite navigation system do not need to decode in their entirety signals, referred to in the remainder of the present description as positioning information, coming from the satellite navigation system. Most satellite navigation systems, namely the GPS and the Galileo system, transmit signals including a field usually called the code phase, corresponding to an extremely regular clock pulse, on which the positioning signal is sent. It is not a date and time, or a “GPS time”, but only a pulse. The GPS and the Galileo system transmit signals including a code phase type field or its equivalent.

According to the invention, the means for receiving positioning information may acquire only the code phase included in said positioning information. To determine thereafter the “GPS time” and the position of the satellites of the satellite navigation system that sent the positioning information, the system of the invention then functions in “masked time”, i.e. it is not the means for receiving the positioning information that participate, but means of the data collection system, and in particular means hosted by one or more ground stations G. Knowing the code phase, positioning consists only in resolving the ambiguity of this measurement, the magnitude of resolving the ambiguity depending on the length of the code on which the phase measurement is effected. Depending on the satellite positioning system used, this ambiguity may be 1 millisecond, 4 milliseconds or 10 milliseconds.

To resolve this ambiguity, said means hosted by one or more ground stations G combine the code phase read in the positioning information with data coming from the data collection system. These means thus constitute means for combining said code phases and information corresponding to portions of messages containing measurements effected for the data collection system via beacons including measuring instruments and means for transmitting messages containing the measurements to satellites S. As already explained, these satellites S establish the link between the objects to be located, tracked or studied and a network of ground stations by relaying the messages containing the measurements to said ground stations G via receiving means R.

As is known in the art, to geolocate an object, it suffices to know the position of the satellites of the satellite navigation system concerned, positioning information from which has been received by the object to be geolocated, and the universal time of these signals, typically the “GPS time”. To achieve this, as already stated, the system of the invention has access to the code phase of the positioning information and messages containing the measurements transmitted by the means of the data collection system equipping the object to be geolocated.

There are different ways to implement the invention, depending on circumstances. To determine the position of the satellites of the satellite navigation system producing the positioning information, there are at least the following two possibilities. First of all, if the code phase is “tagged” when it is forwarded to the collection system, i.e. if it includes an identifier characteristic of the satellite transmitting the positioning signal, it suffices to look up this satellite in the ephemerides relating to the satellite navigation system concerned to determine its position as a function of time. A second possibility consists in “resolving” the position of the satellites by a process of elimination, on the basis of geolocation data intrinsic to the data collection system. By cross referencing this data with the data from the ephemerides relating to the satellite navigation system concerned, the position of the satellites from which the positioning information was received is determined.

There also exists various methods for determining the universal time, for example the “GPS time”, and these methods may be combined.

In a first case, the object D1, D2, D3 to be located including means for effecting measurements and means for transmitting messages containing the measurements to satellites S is configured so that the date and time of the measurement, corresponding to a date and time determined as a function of an internal clock situated on the object to be located, is included in the message containing the measurements. The satellites S knowing the universal time, for example the “GPS time”, it is then possible to work back to the universal time as seen by the object D1, D2, D3 to be located; it suffices to determine the propagation time of the messages containing the measurements from the object D1, D2, D3 to be located to the satellites S, with an accuracy better than the residual ambiguity of the code phase measurement.

In a second case, if the messages containing the measurements sent to the satellites S do not include a date and time of the measurements, it is possible to resolve the universal time seen by the object D1, D2, D3 to be located by analyzing the possibilities, code phase by code phase, in a time interval typically of 10 seconds preceding the date and time of reception of the message containing the measurements by postulating that the measuring means of the data collection system and the associated transmission means equipping the object D1, D2, D3 to be located have not taken more than 10 seconds to send a message containing the measurements and the code phase starting from the time at which the means receiving positioning information for the object D1, D2, D3 to be located to have received a positioning signal for which they have acquired said code phase.

In any event, if there is any ambiguity, or to verify the validity of the calculation, the invention may comprise a step of Doppler measurement of the frequency shift between the transmission of the message containing the measurements and its reception by the satellite S. This measurement enables the object to be geolocated to be situated on a spherical hyperboloid centered on the satellite S and the characteristic of which is given by the Doppler measurement.

It should be noted that, in the conventional way, if a plurality of satellites of the satellite navigation system are visible from the object to be geolocated, a triangulation method may be used. Thus there is no ambiguity as to the position of the object to be geolocated using four visible satellites of the satellite navigation system. With fewer than four satellites visible, it is possible for example to use the method explained above of Doppler measurement by measurement of the collection signal, and thus replacement of a satellite of the satellite navigation system by a satellite of the collection system to establish the point, i.e. to geolocate the object.

To summarize, the main advantage of the invention is to enable accurate geolocation of objects by coupling a data collection system with a satellite navigation system. The system of the invention necessitates a minimum processing time by the means equipping said objects, given the processing effected in “masked time” by remote equipment, typically ground stations of the data collection system. To this end, the system of the invention notably necessitates only acquisition of the code phase of the positioning information coming from the satellites of the satellite navigation system. Acquisition of the code phase classically necessitates only around one millisecond of processing time. Compared to the more than 30 seconds that GPS receivers currently take to acquire the GPS signals, decode the GPS time and consult the ephemerides, the energy savings and thus the improvement in autonomy for these systems is evident. In the system of the invention, the complex processing and notably the determination of the universal time as seen by the objects to be geolocated are effected by remote means such as the ground stations of the data collection system.

It may be noted that the system of the invention may optionally include means for sending their position to the objects to be geolocated once it has been calculated. The system of the invention may also include means for broadcasting data to a network of users, for example the universal time such as the GPS time.

1. A method of geolocation of an equipment, comprising:
receiving, by receiving means situated on said equipment, of positioning information coming from a satellite navigation system, said positioning information containing at least one code phase measurement;
transmitting messages, by transmission means situated on the equipment and belonging to a data collection system, said messages containing said code phase measurements, and measurements on the transmission of the messages, effected by measuring means belonging to said data collection system; and
combining, by processing means remote from the equipment and belonging to said data collection system, said code phase measurements and said measurements on the transmission of the messages, in such a manner as to geolocate said equipment.

2. The geolocation method according to claim 1, wherein said measurements on the transmission of the messages contain a measurement of a date and time of reception by relay means remote from the equipment of the messages transmitted by the transmission means of said data collection system.

3. The geolocation method according to claim 2, further comprising combining said measurement of the date and time of reception and a date and time of transmission of said message by the transmission means in such a manner as to calculate the propagation distance between the equipment and the relay means of the data collection system.

4. The geolocation method according to claim 3, wherein the date and time of transmission of said message by the transmission means are determined by a resolution of ambiguity based on the possible propagation distances between the equipment and the relay means of the data collection system, given the position of said relay means at the moment of reception of said message.

5. The geolocation method according to claim 3, wherein the determination of said transmission date and time utilizes an estimate of the time elapsed between the production of the code phase measurements and the transmission of the message via the data collection system to reduce the ambiguity resolution domain.

6. The geolocation method according to claim 1, wherein said measurements on the transmission of the messages contain a Doppler measurement of a difference between a frequency at which the messages are transmitted by the transmission means and a frequency at which said messages are received by the relay means of the system for collecting those same messages.

7. The geolocation method according to claim 1, further comprising determining an absolute position of the satellite or satellites of the satellite navigation system originating said positioning information, the determining comprising associating said code phase measurements with an identifier characteristic of the satellite that sent said positioning information concerned, said identifier enabling determination of the absolute position of the satellite or satellites of the satellite navigation system by consultation of an ephemerides relating to the satellite navigation system concerned.

8. The geolocation method according to claim 1, further comprising determining an absolute position of the satellite or satellites of the satellite navigation system originating said positioning information, the determining comprising resolving a position of one or more satellites by comparing a set of possible positions determined as a function of an ephemerides of the satellite navigation system concerned with geolocation information specific to said data collection system.

9. A system for geolocation of an equipment, the system comprising:
means situated on said equipment for receiving positioning information from a satellite navigation system, said positioning information containing at least one code phase measurement; and
transmission means, situated on said equipment and belonging to a data collection system, for sending messages containing said code phase measurements and measurements on the transmission of the messages effected by measurement means belonging to said data collection system,
wherein the system is configured to perform the method according to claim 1.

10. The geolocation system according to claim 9, further comprising relay means and processing means remote from said equipment and belonging to said data collection system, respectively comprising a network of satellites and a network of ground stations.

11. The geolocation system according to claim 9, wherein the equipment supplies current to said positioning information receiving means only during a time period necessary and sufficient to effect said code phase measurements on the signals coming from the satellite navigation system.

12. The geolocation system according to claim 9, wherein the system returns to the equipment a message including its geolocation.

13. The geolocation system according to claim 9, wherein the system broadcasts continuously to a network of users the absolute time provided by the satellite navigation system.
